(19) United States
(12) Patent Application Publication
(10) Pub. No.: US 2024/0070729 A1
(43) Pub. Date: Feb. 29, 2024

(54) NAVIGATION PATHS FOR DIRECTING USERS TO LOCATIONS WITHIN A PHYSICAL RETAIL STORE USING EXTENDED REALITY

(71) Applicant: Micron Technology, Inc., Boise, ID (US)

(72) Inventors: Saideep TIKU, Folsom, CA (US); Poorna KALE, Folsom, CA (US)

(21) Appl. No.: 17/823,745

(22) Filed: Aug. 31, 2022

(51) Int. Cl. G06Q 30/02; G06Q 10/08; G06Q 30/06

(52) U.S. Cl. CPC G06Q 30/0281; G06Q 10/087; G06Q 30/0633; G06Q 30/0639

(57) ABSTRACT

In some implementations, an extended reality (XR) device may receive, via an interface of the XR device, an indication of items to be purchased. The XR device may identify one or more physical retail stores that carry the items. The XR device may identify one or more recommended items based on the theme. The XR device may provide, via the interface, a list of the one or more physical retail stores. The XR device may detect that the XR device is within a physical retail store, of the one or more physical retail stores, based on a geographic location associated with the XR device. The XR device may provide, via the interface, an in-store navigation path to direct a user of the XR device via overlayed audio-visual cues to locations within the physical retail store at which the items are held.

### TECHNICAL FIELD

The present disclosure generally relates to extended reality (XR) devices and, for example, navigation paths for directing users to locations within a physical retail store using XR.

### BACKGROUND

Extended reality (XR) may blend a physical world (or real world) and a virtual world (or digital world) to create a more personalized, immersive visual experience. XR may encompass augmented reality (AR), mixed reality (MR), and virtual reality (VR). AR may provide an interactive experience of a physical-world environment, in which objects that reside in the physical world may be enhanced by computer-generated perceptual information. MR may merge physical and virtual worlds to produce new environments and visualizations, in which physical and digital objects may co-exist and interact in real time. VR may provide a fully virtual world without an intervention of the physical world. XR may be across multiple sensory modalities, including visual, auditory, haptic, somatosensory, and/or olfactory. XR may be useful across a wide variety of applications, such as gaming, healthcare, retail, customer service, and/or manufacturing.

### BRIEF DESCRIPTION OF THE DRAWINGS

FIGS. 1A-1D are diagrams of an example related to directing users to locations within a physical retail store using extended reality (XR).

FIG. 2 is a diagram illustrating an example of communications between multiple XR devices.

FIG. 3 is a diagram illustrating an example environment in which systems and/or methods described herein may be implemented.

FIG. 4 is a diagram of example components of one or more devices of FIG. 3.

FIGS. 5-6 are flowcharts of example processes relating to directing users to locations within a physical retail store using an XR device.

### DETAILED DESCRIPTION

A customer may form a list of items needed to be purchased. The items may be for a specific event (e.g., a birthday party, an anniversary, or a get-together with friends). The customer may research physical retail stores within a vicinity that may carry the items. The physical retail stores may be brick-and-mortar stores, as opposed to online stores. For example, the customer may search, using an online search engine, for physical retail stores (e.g., general and/or theme-specific physical retail stores, such as party stores) within the vicinity that may carry the items. In some cases, a single physical retail store may not carry all of the items, and the customer may need to visit multiple physical retail stores to purchase all of the items. In some cases, items at one physical retail store may be more expensive or less expensive as compared to another physical retail store, and the customer may spend time determining which physical retail store offers the best combination of price, convenience, and/or distance. For example, a first physical retail store may offer all of the items although some of the items are at a higher price, whereas a second physical retail store may offer some of the items at a lower price. However, the convenience of visiting only the first physical retail store and not the second physical retail store may be a priority for the customer.

After the customer forms the list of items and determines a physical retail store that carries at least some of the items, the customer may arrive at the physical retail store. If the customer is already familiar with the physical retail store, the customer may know which areas of the physical retail store (e.g., which aisles of the store) carry the items on the list. If the customer is not familiar with the physical retail store, the customer may explore the different aisles of the physical retail store until the items are found. The customer may pick up the items on the list, and then checkout of the physical retail store. In some cases, the customer may then visit another physical retail store to purchase additional items.

The customer may spend time searching for physical retail stores that carry the items needed, which may waste computing resources and network resources associated with a computing device used by the customer to perform the searching. In some cases, the customer may be uncertain as to whether a particular physical retail store carries a particular item, and the customer may need to spend time calling the physical retail store to speak to a physical retail store employee, which may also waste computing resources and network resources associated with the computing device used by the customer. In some cases, the customer may determine that a particular physical retail store generally carries a particular item, but the customer may not be easily able to determine whether that item is in stock or not at the physical retail store. Only after visiting the physical retail store, the customer may determine that the item is out of stock. When the customer searches for physical retail stores on their own, they may be more likely to overlook certain physical retail stores that may carry the items on the list, or physical retail stores that may carry the items at a lower price.

The customer may need to determine the list of items on their own without any assistance. The customer may be unaware of items that are commonly purchased for certain events. By the time the customer realizes that a certain item may be needed, it may be too late for the customer to go back to the physical retail store. After the customer arrives at the physical retail store, the customer may be unable to quickly locate the items on the list. The customer may need to walk aisle-to-aisle to look for the items on the list. Sometimes, even if the customer is in the correct aisle, locating a specific item on a shelf may be cumbersome when there are so many items from which to choose. In some cases, the customer may believe a certain item is in a certain aisle of the store, but that item may be in a completely different aisle and the customer wastes time searching for the item. The customer may wish to ask a store employee for assistance, but a store employee may not be easily found. All of these problems may cause an event planning and shopping experience to be frustrating for the customer.

In some implementations described herein, to solve the problems described above, as well as identifying physical retail store(s) that carry certain items and navigating within a physical retail store to look for items, a technical solution is described herein for providing navigation paths for directing users to locations within a physical retail store using extended reality (XR). A user of the XR device (e.g., a customer of a physical retail store) may indicate, via an interface, items to be purchased. The items may include a single item or multiple items. The XR device, in conjunction with a server, may identify physical retail stores (e.g., a single physical retail store or multiple physical retail store) that carry the items. The XR device may identify the physical retail stores based on a category (or theme) associated with the items, user profile information, and/or real-time item inventory information. The XR device may identify the physical retail stores based on distance, price, and other factors indicated in the user profile information. The XR device may indicate, to the user via the interface, a list of physical retail stores that carry the items. Further, the XR device, in conjunction with the server, may identify recommended items that are related to the items indicated by the user, which may be based on the category associated with the items. The list of physical retail stores may carry the recommended items as well.

In some implementations, after the XR device (and the user carrying the XR device) arrive at a physical retail store, from the list of physical retail stores, the XR device may provide, via the interface, an in-store navigation path to direct the user via overlayed audio-visual cues to locations within the physical retail store at which the items are held. The XR device may use store information that includes a map of the physical retail store, as well as information regarding a current location of the XR device within the physical retail store, to guide the user through the physical retail store using the overlayed audio-visual cues. The XR device may detect when an item from the list is added to a shopping cart, and the XR device may determine a next item from the list and provide the overlayed audio-visual cues to direct the user to the next item.

In some implementations, the user does not need to manually search for the physical retail stores that carry the items. Rather, the XR device and/or the server may determine which physical retail stores carry the items. The XR device and/or the server may have access to a database of store information, which may include real-time item inventory information for each physical retail store. The XR device and/or the server may consider other various factors, such as distance, price, etc. As a result, the user may be promptly provided with the list of physical retail stores, without having to spend an inordinate amount of time researching which physical retail stores to visit. The user may be presented with recommended items, which may be related to the items specified by the user. As a result, the user may become aware of other items for purchase in the same category. The user may be guided within the physical retail store to find the items to be purchased. The user may be presented with the overlayed audio-visual cues, which may help the user to navigate through the aisles in the physical retail store and locate the items to be purchased. As a result, the user does not need to waste time finding the items in the physical retail store and/or asking store employees for assistance.

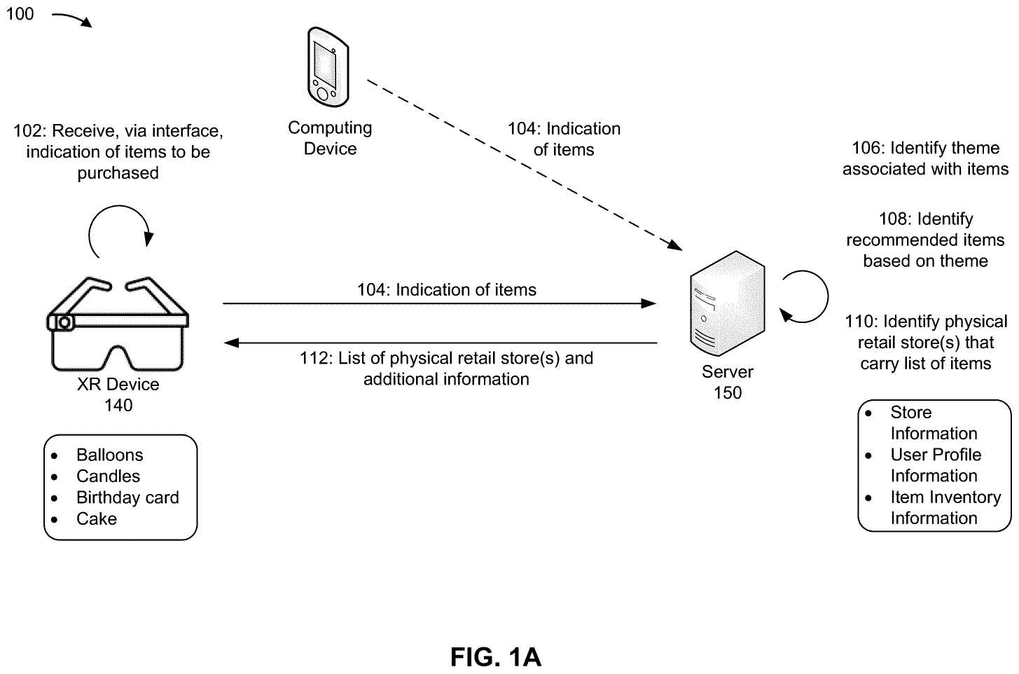

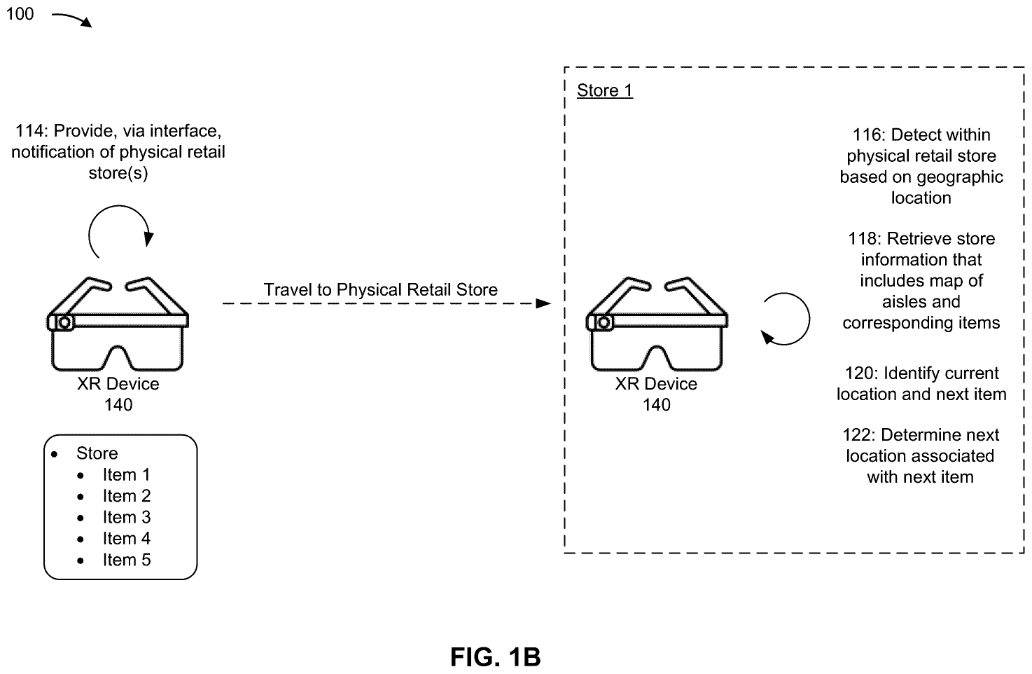

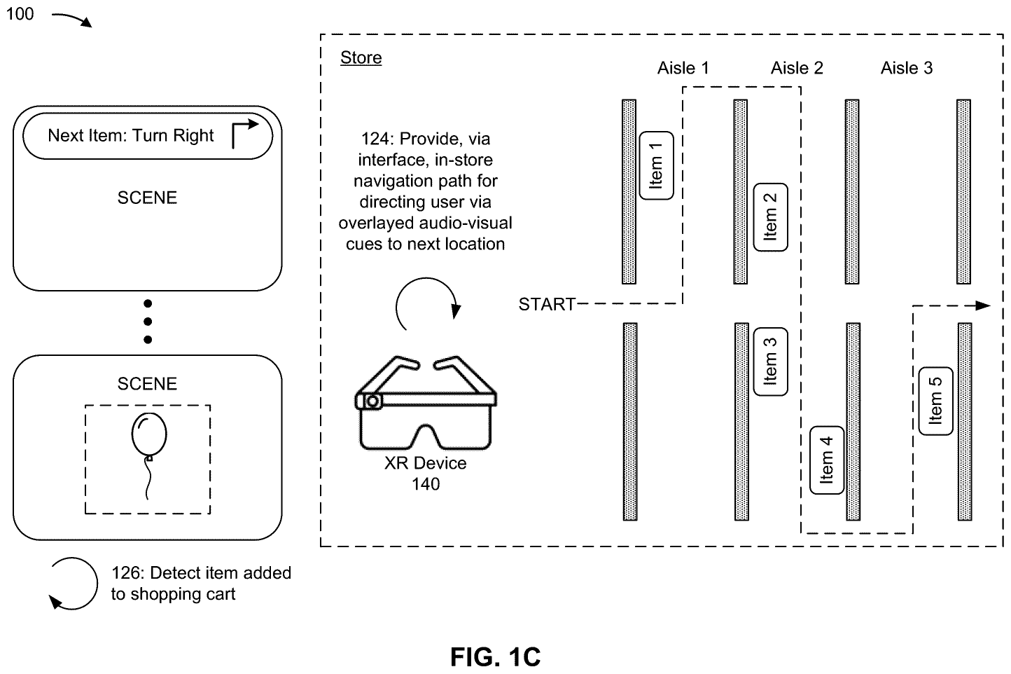

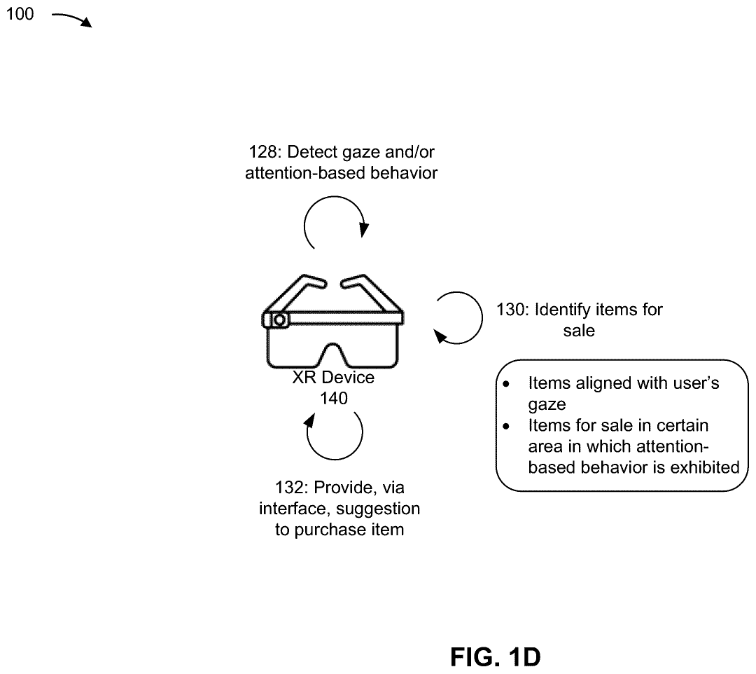

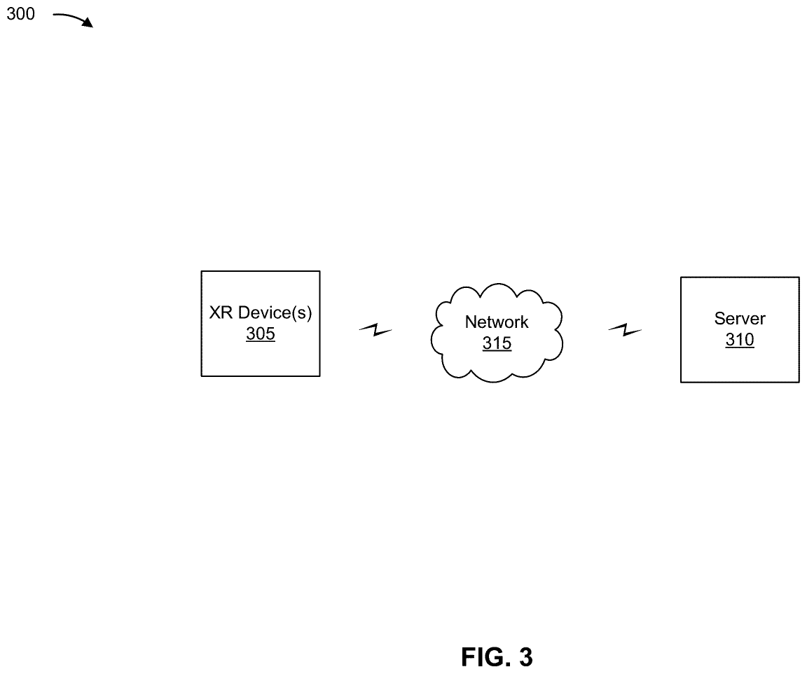

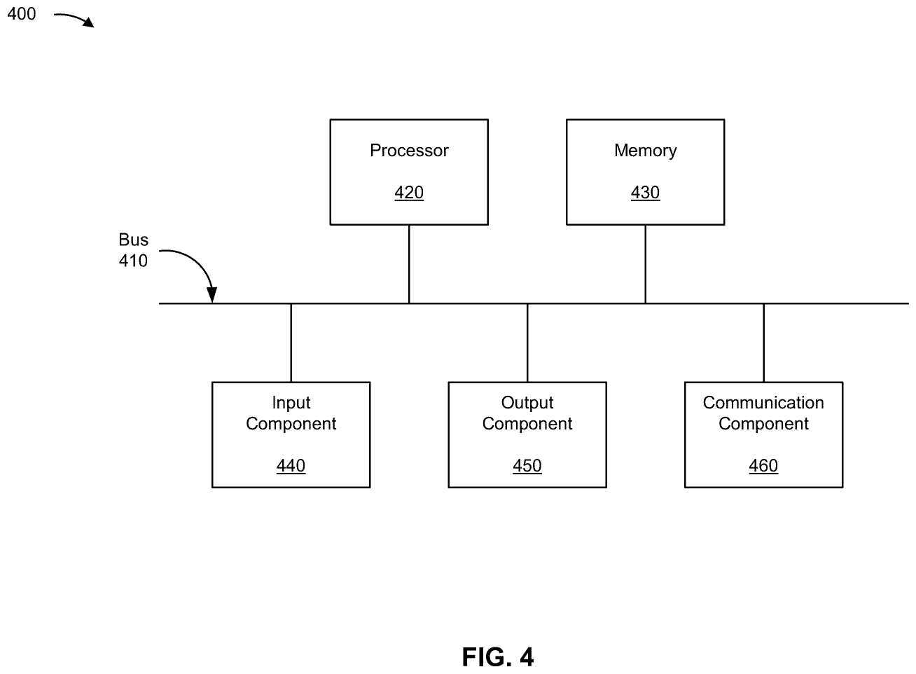

FIGS. 1A-1D are diagrams of an example 100 related to directing users to locations within a physical retail store using XR. As shown in FIGS. 1A-1D, example 100 includes XR devices, such as XR device 140, and a server 150. These devices are described in more detail in connection with FIGS. 3 and 4.

In some implementations, the XR device 140 may be a head-mounted display worn by a user. Alternatively, the XR device 140 may be a mobile device carried by the user. The XR device 140 may provide augmented reality (AR), mixed reality (MR), and/or virtual reality (VR) capabilities. In some implementations, the server 150 may be associated with a cloud computing system or an edge computing system.

In some implementations, the XR device 140 and/or the server 150 may support a deep learning accelerator (DLA). The DLA may be a hardware architecture designed and optimized for increased speed, efficiency, and accuracy when running deep learning algorithms, such as convolutional neural networks (CNNs), recurrent neural networks (RNNs), generative adversarial networks (GANs), and others. The DLA may enable inference tasks to be performed more rapidly and using less energy as compared to general-purpose computers.

In some implementations, the DLA may by supported/used for processing and learning with respect to various tasks. Such tasks, which are further described herein, may include identifying physical retail stores that carry items, determining categories associated with items, determining recommended items associated with categories, and/or identifying physical retail stores based on user profile information and real-time item inventory information.

As shown in FIG. 1A, and by reference number 102, the XR device 140 may receive, via an interface, an indication of items to be purchased. The items may be a single item or multiple items. The XR device 140 may receive, via the interface, the indication of items from the user associated with the XR device 140. In some implementations, the interface may be a voice interface. For example, the XR device 140 may receive, via the voice interface, the indication of items based on the user speaking the items to be purchased. In some implementations, the interface may be a selection-based interface. For example, the XR device 140 may receive, via the selection-based interface, the indication of items based on hand movements of the user (e.g., hand motions and/or finger motions) or via hand controllers. The XR device 140 may project a list of possible items, and the user may select certain items on the list based on the hand movements or the hand controllers.

In some implementations, a computing device (e.g., a mobile device, a tablet computer, or a desktop computer) may provide an application (or web browser) that allows the user to enter (e.g., via text) which items are to be purchased. The application may allow the user to manually enter item names, and/or search for possible items and then add certain items to a list of desired items. The computing device may be separate from the XR device 140 that is used by the user when visiting a physical retail store to purchase the items. The computing device may be able to communicate with the server and/or the XR device. The computing device may receive, via an interface of the computing device, an indication of items to be purchased.

As an example, the XR device 140 may receive, via a voice interface, an indication of items to be purchased, which may include balloons, candles, a birthday card, and cake. The user may speak out loud the different items to be purchased. The XR device 140 may detect the sounds spoken by the user. The XR device 140 may use voice recognition and/or related techniques to determine which items have been spoken by the user. The items may be added to a list of items to be purchased.

As shown by reference number 104, the XR device 140 (or the computing device) may transmit, to the server, the indication of items to be purchased. The server may receive, from the XR device 140, the indication of items to be purchased.

As shown by reference number 106, the server 150 may determine the category (or theme) associated with the items. The server 150 may determine a combination of categories associated with the items. The server 150 may determine the category using various classification algorithms. The server 150 may analyze the items and determine whether the items fit under a common category (or multiple categories). As an example, when the items to be purchased include balloons, candles, a birthday card, and cake, the server 150 may determine that a category associated with the items is “birthday party.” In some aspects, the XR device 140 may receive, via the interface, an indication of the category, and the XR device 140 may transmit the indication of the category to the server 150.

As shown by reference number 108, the server 150 may determine the recommended items associated with the category. The recommended items may be items having the same characteristics, features, theme, price, etc. as compared to the items indicated by the user. The recommended items may be complementary to the items indicated by the user. As an example, for the category of “birthday party,” the recommended items may include wrapping paper, party hats, cookies, and other birthday party related items. The recommended items may be based on item purchases made by other users. For example, when 85% of users that purchase balloons also purchase streamers, the server 150 may recommend that streamers be purchased as well.

In some implementations, the server 150 may determine the recommended items based on a set of preferences associated with the user. The set of preferences may be defined by the user. The set of preferences may include various types of information about the user, such as food restrictions (e.g., animal protein), food allergies (e.g., gluten-free), price preferences (e.g., no items above $50), clothing preferences (e.g., organic cotton), toy preferences (e.g., wooden toys over plastic toys), and others. The set of preferences may indicate previous buying habits. When the server 150 identifies a potential recommended item, the server 150 may check the potential recommended item against the set of preferences. When the potential recommended item conflicts with the set of preferences, the server 150 may discard the potential recommended item. When the potential recommended item is aligned with the set of preferences, the server 150 may provide that item as a recommended item. In other words, the server 150 may verify that the potential recommended item is aligned with the set of preferences. The set of preferences may be used for identifying items, as opposed to the user profile information, which may be used for identifying physical retail stores.

As shown by reference number 110, the server 150 may identify the physical retail stores (e.g., a single physical retail store or multiple physical retail stores) that carry the items. The items may be the items indicated by the user and/or the recommended items. The server 150 may attempt to minimize a number of physical retail stores for the user to visit. The server 150 may identify the physical retail stores based on the category associated with the items. For example, the physical retail stores may offer items for sale that correspond to the category. The server 150 may identify the physical retail stores based on user profile information. The user profile information may indicate a base location associated with the user and a maximum distance that the user is willing to travel (e.g., 5 miles), a cost budget, past physical retail stores visited by the user, and/or user reviews of physical retail stores. The user reviews may be from the user or from other users. The user profile information may be used for identifying physical retail stores. The server 150 may identify the physical retail stores based on real-time item inventory information. The server 150 may determine, for a certain item, whether that item at a particular physical retail store is available or whether there is currently no inventory of that item at the particular physical retail store. The server 150 may identify the physical retail stores based on the category, the user profile information, and/or the real-time item inventory information.

As an example, when the user wishes to buy items related to a birthday party, the server 150 may identify a physical retail store that carries items related to birthday parties. The server 150 may identify a party store that carries the items. The server 150 may determine that the party store carries all of the items needed by the user, such that the user does not have to visit multiple physical retail stores. The server 150 may determine that the party store is located within 3 miles of the user's home, which may be aligned with the user's distance preferences. The server 150 may identify the party store based on the user having shopped at the party store in the past and/or providing a favorable review of the party store. The server 150 may identify the party store based on other user reviews and/or a user rating. The server 150 may determine that the items are currently available and in-stock at the party store. In some cases, the server 150 may consider another party store that could potentially be recommended to the user, but the server 150 may determine to not recommend the other party store because some items are out of stock and/or the other party store exceeds the user's distance preferences.

In some aspects, the server 150 may identify the physical retail stores based on a combination of one or more factors, which may include the category associated with the items, recommended items associated with the category, the user profile information, and the real-time item inventory information. The one or more factors may be weighted separately from each other. For example, the user profile information may be weighted higher than the recommended items.

As shown by reference number 112, the server 150 may transmit, to the XR device 140, a list of the physical retail stores identified as carrying the items. The physical retail stores may be ranked based on one or more factors, such as cost of items, preferences of items/stores, distance, etc. The server 150 may transmit, to the XR device 140, store information associated with the physical retail stores, which may include store address information, store hours, and store contact information. In some implementations, the server 150 may transmit additional information to the XR device 140, where the additional information may be associated with the items to be purchased. The additional information may include an expected shopping duration, a distance associated with traveling to the physical retail stores, and/or a cost associated with the items to be purchased. The XR device 140 may provide, via the interface, the additional information to the user.

In some implementations, the XR device 140 may not offload certain data processing to the server 150. The XR device 140 may determine, using local processing, the theme associated with the items, the recommended items based on the theme, and/or the physical retail stores that carry the items (e.g., items indicated by the user and/or the recommended items). In other words, the XR device 140 may have sufficient processing capability to perform such tasks without involving the server 150.

As shown in FIG. 1B, and by reference number 114, the XR device 140 may provide, via the interface, the indication of the physical retail stores identified as carrying the items. The XR device 140 may provide, via the interface, the store information associated with the physical retail stores. The XR device 140 may provide, via the interface, the additional information. As an example, the XR device 140 may provide, via the interface, an indication of a first store that carries five items. The XR device 140 may receive, via the interface, feedback from the user that accepts the physical retail stores indicated by the server 150. In some cases, the XR device 140 may receive, via the interface, feedback that the user rejects the physical retail stores indicated by the server 150, or that the user only accepts some of the physical retail stores indicated by the server 150. In this case, the server 150 may adjust which physical retail stores are to be visited by the user based on the feedback.

In some implementations, the XR device 140, and the user associated with the XR device 140, may travel to a physical retail store indicated by the server 150. The physical retail store may be the first physical retail store of multiple physical retail stores, or the physical retail store may be the only physical retail store need to visit because the physical retail store carries all of the items needed by the user.

As shown by reference number 116, the XR device 140 may detect that the XR device 140 is within the physical retail store based on a geographic location associated with the XR device 140. The XR device 140 may determine the geographic location, and compare the geographic location to the store information received from the server 150. Based on the comparison, the XR device 140 may determine a specific physical retail store in which the XR device 140 is located. Alternatively, the XR device 140 may receive, via the interface, an indication of the physical retail store in which the XR device 140 is located.

In some implementations, the XR device 140 may be worn by the user outside of the physical retail store. For example, the user may wear or carry the XR device 140 at home. The user may use the XR device 140 to perform shopping using another devices on wheels, such as an autonomous shopping cart, which may be located within the physical retail store.

As shown by reference number 118, the XR device 140 may retrieve, from the server 150, store mapping information associated with the physical retail store. The store mapping information may indicate a map of store aisles and corresponding items that are available for sale in the store aisles. The map may indicate, for a particular aisle, shelf numbers associated with that particular aisle. A given shelf number may hold a certain number of items. The XR device 140 may receive the store mapping information prior to arriving at the physical retail store (e.g., when the XR device 140 receives the indication of the physical retail stores from the server 150), or after the XR device 140 arrives at the physical retail store. The XR device 140 may download the store mapping information from the server 150 prior to arriving at the physical retail store in case the physical retail store does not have good network coverage. In some implementations, the XR device 140 may receive the store mapping information from the same server 150 that provides the indication of the physical retail stores, or from a different server 150 (e.g., a server 150 that is associated with the physical retail store). The XR device 140 may access a database associated with the physical retail store using REST-link application programming interfaces (APIs), where the database may include detailed information of store floorplans, product placements, and item prices. The XR device 140 may be able to access different databases for different physical retail stores in order to retrieve the appropriate store mapping information.

As shown by reference number 120, the XR device 140 may determine, using a camera of the XR device 140, a current location within the physical retail store. The current location may be associated with the XR device 140 and/or the user wearing (or carrying) the XR device 140. The XR device 140, based on object recognition or other related techniques employed by the camera, may determine that the user is in a particular area of the physical retail store (e.g., an entryway or a particular aisle). The XR device 140 may detect an entryway sign, aisle sign numbers, etc. using object recognition, which may enable the XR device 140 to determine the current location within the physical retail store. In some implementations, the XR device 140 may determine the next item to be purchased. The next item may be a first item on a list of items to be purchased at the physical retail store, or the next item may be a subsequent item on the list of items. The next item may be a next closest item as compared to a previous item. The next item may be an item initially indicated by the user, or the next item may be a recommended item.

As shown by reference number 122, the XR device 140 may determine, based on the store mapping information, a next location in the physical retail store that is associated with the next item. The next location may be a specific aisle or a general area of the physical retail store (e.g., a bakery area, a produce area, or an apparel area). The XR device 140 may determine the next location based on localized processing, as opposed to the processing occurring on the server 150, which may reduce latency.

As shown in FIG. 1C, and by reference number 124, the XR device 140 may provide, via the interface, an in-store navigation path to direct the user via overlayed audio-visual cues to the next location at which the next item is held. The overlayed audio-visual cues may direct the user from the current location to the next location associated with the next item. The overlayed audio-visual cues may include audio commands (e.g., walk to aisle 3 to purchase your next item) to direct the user. The overlayed audio-visual cues may include visual directional signs (e.g., turn right or turn left) to direct the user. The overlayed audio-visual cues may be presented via a speaker of the XR device 140 and/or a display of the XR device 140.

As shown by reference number 126, the XR device 140 may detect, via the camera, that the next item has been added to a shopping cart (e.g., the user physically places the next item into the shopping cart). The camera may use object recognition or other related techniques, such that when the user picks up the next item, the camera may scan the next item and determine that the next item corresponds to one of the items from the list. The XR device 140 may update a status of the next item that is added to the shopping cart. For example, the status may be changed from “not in cart” to “added to cart”. After the next item is added, the XR device 140 may direct the user to another location within the physical retail store. The other location may be associated with another item, which may be based on the XR device 140 determining that there are remaining items from the list to be purchased. Alternatively, the other location may be a checkout location in the physical retail store, which may be based on the XR device 140 determining that all items on the list have been added to the shopping cart.

In some implementations, the XR device 140 may provide, via the interface, the in-store navigation path to direct the user via the overlayed audio-visual cues to locations within the physical retail store at which the items are held. The in-store navigation path may be mapped for the user with items on the list tagged or highlighted at appropriate locations (e.g., aisles or rows) in the physical retail store. The XR device 140 may generate the in-store navigation path based on the store mapping information and the items to be purchased. The XR device 140 may provide the overlayed audio-visual cues after the user enters the physical retail store. The XR device 140 may identify a location (e.g., an aisle number and/or shelf number) associated with each item to be purchased. The XR device 140 may determine the in-store navigation path based on the identified locations. In some implementations, the XR device 140 may generate the in-store navigation path, such that the user only walks through aisles in which needed items are located. In this case, the in-store navigation path may be the shortest path for visiting the locations within the physical retail store at which the items are held. In other words, the in-store navigation path may be optimized for time or being a fastest path for reaching the items, and the in-store navigation path may be adjusted dynamically when the user deviates from the in-store navigation path. In some implementations, the XR device 140 may generate an in-store navigation path that directs the user to other aisles within the physical retail store, where the other aisles contain items that may be of interest to the user. For example, the other aisles may contain items that are associated with the same category. Whether the XR device 140 provides the shortest in-store navigation path or a non-shortest in-store navigation path may depend on the user preference information. The XR device 140 may provide the in-store navigation path to cover the items on the list, and may also lead the user to potential areas of interest (e.g., adjacencies), as identified by the server 150 and/or the XR device 140. The potential areas of interest may hold recommended items, which may be related to the category of the items to be purchased.

As an example, based on a list of five items to be purchased, the server 150 may generate an in-store navigation path that directs the user to a first aisle to pick up a first item. The in-store navigation path may direct the user to a second aisle to pick up a second item, a third item, and a fourth item. The in-store navigation path may direct the user to a third aisle to pick up a fifth item. In this example, the server 150 may generate the in-store navigation path such that the user only walks in parts of aisles in which needed items are located, and the user is not directed to walk in other aisles of the physical retail store.

As shown in FIG. 1D, and by reference number 128, the XR device 140 may detect, using an eye tracking camera, a gaze associated with the user. The XR device 140 may detect the gaze associated with the user using eye tracking. The XR device 140 may capture, using the camera, a field of view associated with the user. The XR device 140 may be able to correlate the gaze associated with the user to the field of view associated with the user, which may allow the XR device 140 to capture images of items that are being looked at by the user. In some implementations, the XR device 140 may detect, using a sensor of the XR device 140 (e.g., an accelerometer), an attention-based behavior of the user while the user is in a certain area of the physical retail store. For example, the XR device 140 may determine when the user is standing in a certain aisle for a period of time that satisfies a threshold, which may indicate that the user is particularly interested in items in this certain aisle.

As shown by reference number 130, the XR device 140 may identify, based on object recognition, an item for sale in the physical retail store that is aligned with the gaze associated with the user. In other words, the XR device 140 may be able to recognize the item that is being looked at by the user based on the gaze associated with the user. The XR device 140 may determine whether the item being looked at by the user corresponds to the category. When the item does not correspond to the category, the XR device 140 may take no further action. The XR device 140 may monitor the user's gaze to indirectly quantify the user's interest in other items. In some implementations, the XR device 140 may identify, using the camera (e.g., a camera separate from the eye tracking camera) and object recognition, an item for sale in the certain area of the physical retail store that corresponds to the category. In some cases, when the XR device 140's camera is turned off, the XR device 140 may capture location information and pose information associated with the user in an aisle, and when the XR device 140 already stores product placement information, the XR device 140 may be able to detect which items may be of interest to the user.

As shown by reference number 132, when the item does correspond to the category, the XR device 140 may provide, via the interface, a suggestion to purchase the item. The user may ignore the suggestion, or may decide to purchase the item based on the suggestion. As a result, the XR device 140 may provide suggestions to purchase items that may be of interest to the user, where the items may be related to other items being purchased by the user, and the items may be suggested based on the gaze associated with the user or based on the attention-based behavior of the user. The XR device 140 may suggest items that are aligned with the user's gaze, or items for sale in a certain area in which a certain attention-based behavior is exhibited (e.g., standing for a relatively large period of time in a particular aisle).

In some implementations, when the XR device 140 is inside the physical retail store, the XR device 140 may receive, from the server 150, store information associated with the physical retail store. The store information may indicate information regarding discounted items available for sale at the physical retail store. The XR device 140 may determine, based on the store information, an additional item that is offered for sale at a discounted price, where the additional item may be related to the category (e.g., discounted party decorations, which may be related to a birthday party theme). The XR device 140 may determine, based on the store mapping information, a location associated with the additional item. The XR device 140 may provide, via the interface, the in-store navigation path to direct the user to the location within the physical retail store at which the additional item is held. In some cases, the XR device 140 may indicate to the user, via the interface, the additional item, and the user may be presented with an option to either accept the additional item or decline the additional item.

As indicated above, FIG. 1 is provided as an example. Other examples may differ from what is described with regard to FIG. 1.

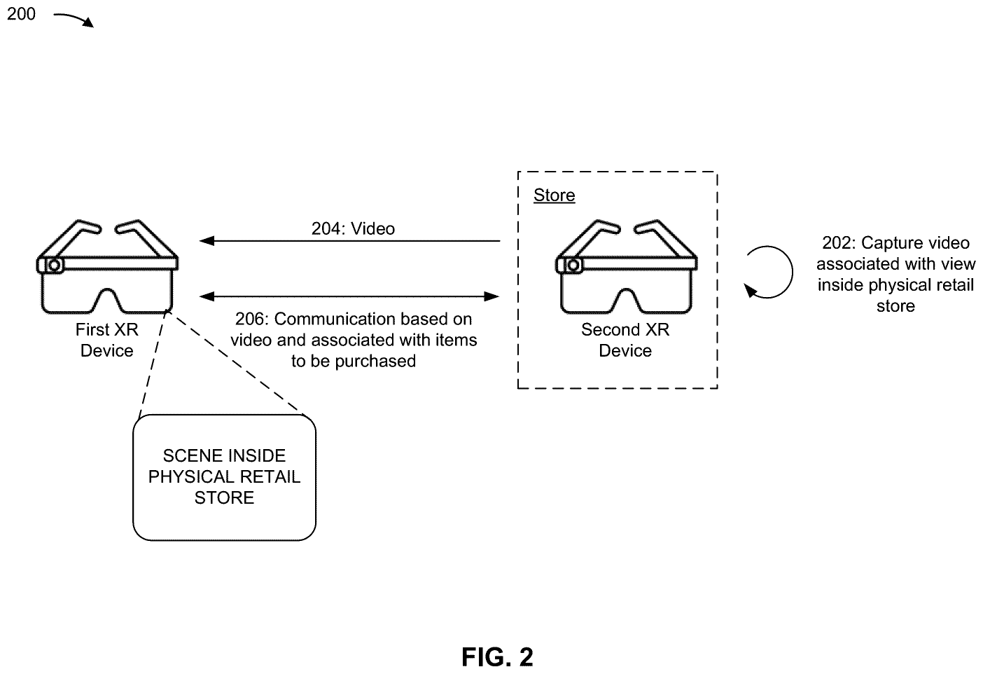

FIG. 2 is a diagram illustrating an example 200 of communications between multiple XR devices. In some cases, the communications may be between an XR device and a non-XR device.

With grocery delivery services, the customer often has no mechanism for communicating with the employee that is doing the shopping for the customer. The customer may be unable to make alterations to the list of items on-the-fly. For example, the customer may specify that green beans should be purchased, but the customer may be unaware that the green beans at the physical retail store on that particular day are of poor quality, and that other vegetables are of better quality on that particular day. However, since green beans are on the list of items, the employee may proceed with getting the green beans, even though the customer may have preferred to not get the green beans (and instead get a different vegetable) had the customer seen the quality of the green beans in real life. The customer may receive items that are of poor quality. For example, the customer may specify that five apples should be purchased, and after receiving a grocery delivery that includes the five apples, the customer may become aware that some of the apples are of poor quality. As a result, grocery delivery services may not always be a quality option for customers.

In some implementations, a first XR device may be associated with a user (or customer). The user may not be physically present in a physical retail store, but rather may be in a different location (e.g., home, office, park, or other places). In some cases, a non-XR device may be associated with the user. The non-XR device may still have camera/streaming capabilities. A second XR device may be associated with an employee of the physical retail store. The employee may be gathering items to be purchased on behalf of the user. The second XR device may provide, via an interface of the second XR device, a list of items to be purchased for the user, which may guide the employee to different locations of the physical retail store to pick up the items on the list.

As shown by reference number 202, the second XR device may capture video associated with a view inside the physical retail store. The captured video may be from the perspective of the employee wearing (or carrying) the second XR device. In other words, as the employee is shopping for the customer, the second XR device may capture the video. The video may indicate specific items being added to a shopping cart, a quantity of the items being added, and/or a quality of the items being added.

As shown by reference number 204, the second XR device may transmit the video to the first XR device. The customer associated with the first XR device may watch the video associated with the inside of the physical retail store, from the perspective of the employee. As a result, the customer may see what the employee sees in near real-time. For example, the customer may see, via the first XR device, the specific items being added to the shopping cart, the quantity of the items being added, and/or the quality of the items being added

As shown by reference number 206, the first XR device may transmit information to the second XR device, where the information may be based on the video received from the second XR device and the items to be purchased. For example, the first XR device may transmit audio data to the second XR device, where the audio data may include an audio message spoken by the customer. The audio message may instruct the employee to perform a specific action when purchasing the items on behalf of the customer (e.g., select a different apple, or skip buying peaches and instead buy mangos). In other words, a two-way interaction may be supported between the first XR device and the second XR device, which may provide the customer with additional control when items are being purchased on their behalf. The customer may be more likely to be satisfied with purchased items.

In some implementations, the second XR device may not necessarily be worn (or carried) by the employee. Rather, the first XR device and the second XR devices may be associated with a pair of friends, spouses, or two people with some other relation. For example, a first person may be wearing the first XR device, and a second person may be wearing the second XR device. The second person may be shopping at the physical retail store, and when looking at a shelf of pasta, be unsure of which specific pasta to purchase. In this case, the second XR device may capture video of the shelf of pasta, which may be shared with the first XR device, such that the first person may be able to see what the second person is seeing. The first XR device and the second XR device may communicate with each other, such that the first person and the second person may have a conversation regarding which pasta to purchase.

As indicated above, FIG. 2 is provided as an example. Other examples may differ from what is described with regard to FIG. 2.

FIG. 3 is a diagram of an example environment 300 in which systems and/or methods described herein may be implemented. As shown in FIG. 3, environment 300 may include one or more XR devices 305, a server 310, and a network 315. Devices of environment 300 may interconnect via wired connections, wireless connections, or a combination of wired and wireless connections.

An XR device 305 may be capable of receiving, generating, storing, processing, providing, and/or routing information associated with directing users to locations within a physical retail store using XR, as described elsewhere herein. The XR device 305 may be a head-mounted device (or headset) or a mobile device. The XR device 305 may provide XR capabilities, which may include AR, MR, and/or VR. The XR device 305 may include various types of hardware, such as processors, sensors, cameras, input devices, and/or displays. The sensors may include accelerometers, gyroscopes, magnetometers, and/or eye-tracking sensors. The XR device 305 may include an optical head-mounted display, which may allow information to be superimposed onto a field of view.

The server 310 includes one or more devices capable of receiving, generating, storing, processing, providing, and/or routing information associated with directing users to locations within a physical retail store using XR, as described elsewhere herein.

The server 310 may include a communication device and/or a computing device. For example, the server 310 may be an application server, a client server, a web server, a database server, a host server, a proxy server, a virtual server (e.g., executing on computing hardware), or a server in a cloud computing system. In some implementations, the server 310 includes computing hardware used in a cloud computing environment.

The network 315 includes one or more wired and/or wireless networks. For example, the network 315 may include a cellular network, a public land mobile network, a local area network, a wide area network, a metropolitan area network, a telephone network, a private network, the Internet, and/or a combination of these or other types of networks. The network 315 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with navigation paths for directing users to locations within a physical retail store using XR. Device 400 may correspond to XR device 305 and/or server 310. In some implementations, XR device 305 and/or server 310 may include one or more devices 400 and/or one or more components of device 400. As shown in FIG. 4, device 400 may include a bus 410, a processor 420, a memory 430, an input component 440, an output component 450, and a communication component 460.

Bus 410 may include one or more components that enable wired and/or wireless communication among the components of device 400. Bus 410 may couple together two or more components of FIG. 4, such as via operative coupling, communicative coupling, electronic coupling, and/or electric coupling. Processor 420 may include a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 may include one or more processors capable of being programmed to perform one or more operations or processes described elsewhere herein.

Memory 430 may include volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 may include one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

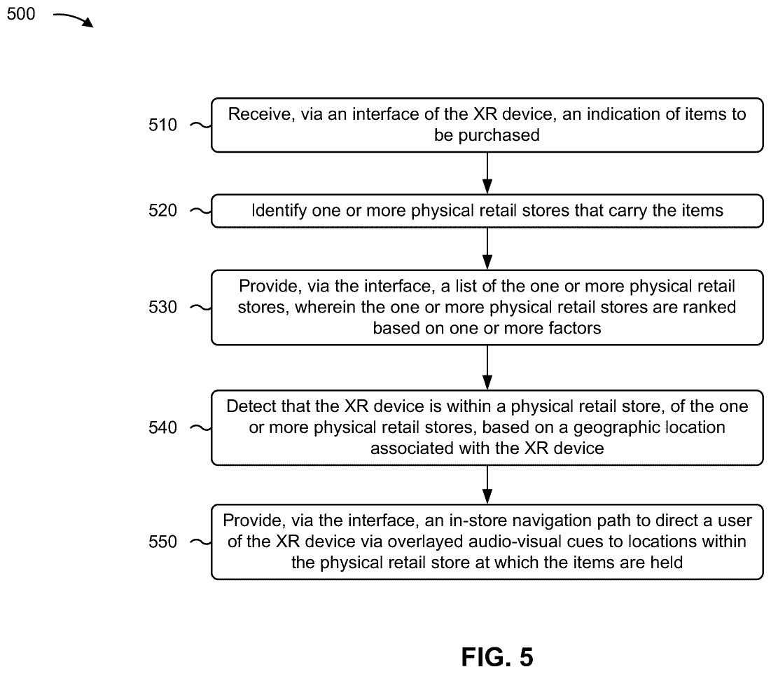

FIG. 5 is a flowchart of an example method 500 associated with navigation paths for directing users to locations within a physical retail store using XR. In some implementations, one or more XR devices (e.g., XR device 305) may perform or may be configured to perform one or more process blocks of FIG. 5. In some implementations, another device or a group of devices separate from or including the one or more XR devices (e.g., server 310) may perform or may be configured to perform one or more process blocks of FIG. 5. Additionally, or alternatively, one or more components of the one or more XR devices (e.g., processor 420, memory 430, input component 440, output component 450, and/or communication component 460) may perform or may be configured to perform one or more process blocks of FIG. 5.

As shown in FIG. 5, the method 500 may include receiving, via an interface of an XR device, an indication of items to be purchased (block 510). As further shown in FIG. 5, the method 500 may include identifying one or more physical retail stores that carry the items (block 520). As further shown in FIG. 5, the method 500 may include providing, via the interface, a list of the one or more physical retail stores (block 530). As further shown in FIG. 5, the method 500 may include detecting that the XR device is within a physical retail store, of the one or more physical retail stores, based on a geographic location associated with the XR device (block 540). As further shown in FIG. 5, the method 500 may include providing, via the interface, an in-store navigation path to direct a user of the XR device via overlayed audio-visual cues to locations within the physical retail store at which the items are held (block 550).

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein, such as the operations described in connection with FIGS. 1A-1D and 2.

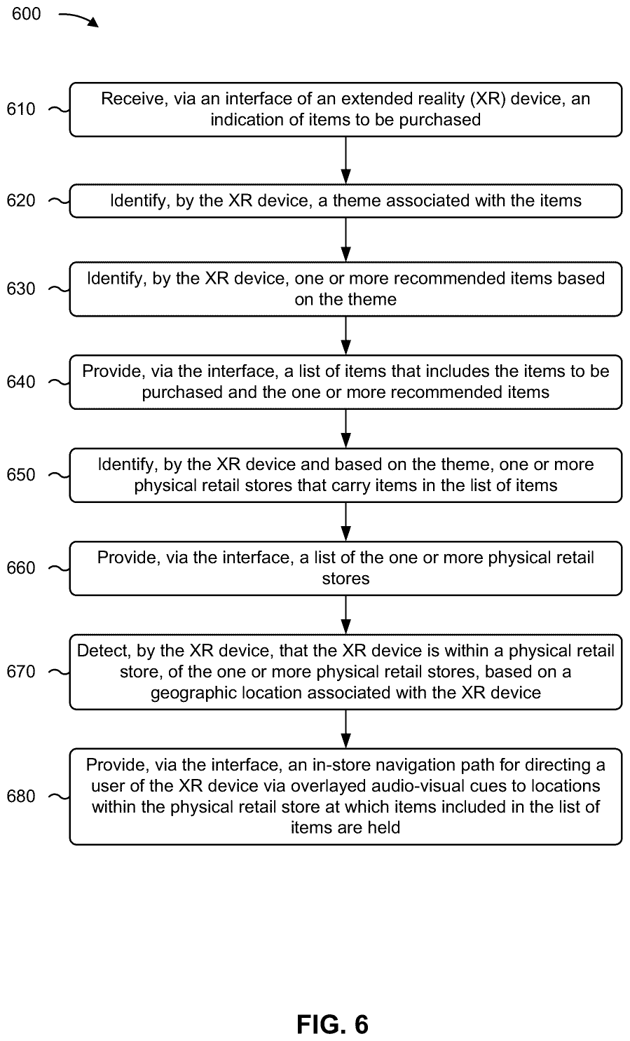

FIG. 6 is a flowchart of an example method 600 associated with navigation paths for directing users to locations within a physical retail store using XR. In some implementations, an XR device (e.g., XR device 305) may perform or may be configured to perform one or more process blocks of FIG. 6. In some implementations, another device or a group of devices separate from or including the XR device (e.g., server 310) may perform or may be configured to perform one or more process blocks of FIG. 6. Additionally, or alternatively, one or more components of the XR device (e.g., processor 420, memory 430, input component 440, output component 450, and/or communication component 460) may perform or may be configured to perform one or more process blocks of FIG. 6.

As shown in FIG. 6, the method 600 may include receiving, via an interface of an XR device, an indication of items to be purchased (block 610). As further shown in FIG. 6, the method 600 may include identifying, by the XR device, a theme associated with the items (block 620). As further shown in FIG. 6, the method 600 may include identifying, by the XR device, one or more recommended items based on the theme (block 630). As further shown in FIG. 6, the method 600 may include providing, via the interface, a list of items that includes the items to be purchased and the one or more recommended items (block 640). As further shown in FIG. 6, the method 600 may include identifying, by the XR device and based on the theme, one or more physical retail stores that carry items in the list of items (block 650). As further shown in FIG. 6, the method 600 may include providing, via the interface, a list of the one or more physical retail stores (block 660). As further shown in FIG. 6, the method 600 may include detecting, by the XR device, that the XR device is within a physical retail store, of the one or more physical retail stores, based on a geographic location associated with the XR device (block 670). As further shown in FIG. 6, the method 600 may include providing, via the interface, an in-store navigation path for directing a user of the XR device via overlayed audio-visual cues to locations within the physical retail store at which items included in the list of items are held (block 680).

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein, such as the operations described in connection with FIGS. 1A-1D and 2.

In some implementations, an XR device includes one or more components configured to: receive, via an interface of the XR device, an indication of items to be purchased; identify one or more physical retail stores that carry the items; provide, via the interface, a list of the one or more physical retail stores; detect that the XR device is within a physical retail store, of the one or more physical retail stores, based on a geographic location associated with the XR device; and provide, via the interface, an in-store navigation path to direct a user of the XR device via overlayed audio-visual cues to locations within the physical retail store at which the items are held.

In some implementations, a method includes receiving, via an interface of an XR device, an indication of items to be purchased; identifying, by the XR device, a theme associated with the items; identifying, by the XR device, one or more recommended items based on the theme; providing, via the interface, a list of items that includes the items to be purchased and the one or more recommended items; identifying, by the XR device and based on the theme, one or more physical retail stores that carry items in the list of items; providing, via the interface, a list of the one or more physical retail stores; detecting, by the XR device, that the XR device is within a physical retail store, of the one or more physical retail stores, based on a geographic location associated with the XR device; and providing, via the interface, an in-store navigation path for directing a user of the XR device via overlayed audio-visual cues to locations within the physical retail store at which items included in the list of items are held.

In some implementations, a system includes a server comprising one or more components configured to: receive, from an XR device, an indication of items to be purchased; identify one or more physical retail stores that carry the items; and transmit, to the XR device, an indication of the one or more physical retail stores; and the XR device comprising one or more components configured to: receive, from the server, the indication of the one or more physical retail stores; and provide, via an interface of the XR device, an in-store navigation path to direct a user of the XR device via overlayed audio-visual cues to locations within a physical retail store, of the one or more physical retail stores, at which the items are held.

The foregoing disclosure provides illustration and description but is not intended to be exhaustive or to limit the implementations to the precise forms disclosed. Modifications and variations may be made in light of the above disclosure or may be acquired from practice of the implementations described herein.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. An extended reality (XR) device, comprising:
one or more components configured to:
receive, via an interface of the XR device, an indication of items to be purchased;
identify one or more physical retail stores that carry the items;
provide, via the interface, a list of the one or more physical retail stores, wherein the one or more physical retail stores are ranked based on one or more factors;
detect that the XR device is within a physical retail store, of the one or more physical retail stores, based on a geographic location associated with the XR device; and
provide, via the interface, an in-store navigation path to direct a user of the XR device via overlayed audio-visual cues to locations within the physical retail store at which the items are held.

2. The XR device of claim 1, wherein the one or more components are configured to:
determine a category associated with the items; and
identify the one or more physical retail stores based on the category associated with the items, wherein the one or more physical retail stores offer items for sale that correspond to the category.

3. The XR device of claim 1, wherein the one or more components are configured to:
determine a category associated with the items; and
determine one or more recommended items associated with the category, wherein the one or more recommended items are aligned with a set of preferences indicated by the user;
determine that the one or more physical retail stores carry the one or more recommended items; and
provide, via the interface, the in-store navigation path to direct the user to locations within the physical retail store at which the one or more recommended items are held.

4. The XR device of claim 1, wherein the one or more components are configured to:
identify the one or more physical retail stores based on user profile information and real-time item inventory information, wherein the user profile information indicates one or more of: a base location associated with the user and a maximum distance that the user is willing to travel, a cost budget, past physical retail stores visited by the user, or user reviews of physical retail stores.

5. The XR device of claim 1, wherein the one or more components are configured to:
retrieve, from a server, store mapping information that indicates a map of store aisles and corresponding items that are available for sale in the store aisles;
determine, using a camera of the XR device, a current location within the physical retail store;
determine a next item to be purchased, wherein the next item is included in the items, or the next item is a recommended item that corresponds to a category associated with the items;
determine, based on the store mapping information, a next location in the physical retail store that is associated with the next item; and
provide, via the interface, the in-store navigation path to direct the user via the overlayed audio-visual cues from the current location to the next location associated with the next item.

6. The XR device of claim 1, wherein the one or more components are configured to:
determine additional information associated with the items to be purchased, wherein the additional information includes an expected shopping duration, a distance associated with traveling to the one or more physical retail stores, and a cost associated with the items; and
provide, via the interface, the additional information.

7. The XR device of claim 1, wherein the one or more components are configured to:
detect, via a camera of the XR device, that one of the items is added to a shopping cart; and
provide, via the interface, the in-store navigation path to direct the user to a next location within the physical retail store, wherein the next location is associated with a next item included in the items or a checkout location in the physical retail store.

8. The XR device of claim 1, wherein the one or more components are configured to:
detect, using a camera of the XR device, a gaze associated with the user;
identify, based on an object recognition, an item for sale in the physical retail store that is aligned with the gaze associated with the user;
determine that the item corresponds to a category associated with the items; and
provide, via the interface, a suggestion to purchase the item.

9. The XR device of claim 1, wherein the one or more components are configured to:
detect, using a sensor of the XR device, an attention-based behavior of the user while the user is in a certain area of the physical retail store;
identify, based on an object recognition, an item for sale in the certain area of the physical retail store;
determine that the item corresponds to a category associated with the items; and
provide, via the interface, a suggestion to purchase the item.

10. The XR device of claim 1, wherein the one or more components, to identify the one or more physical retail stores, are configured to:
transmit, to a cloud computing system or an edge computing system, an indication of the items; and
receive, from the cloud computing system or the edge computing system, an indication of the one or more physical retail stores that carry the items.

11. The XR device of claim 1, wherein the in-store navigation path is a shortest path for visiting the locations within the physical retail store at which the items are held.

12. The XR device of claim 1, wherein the XR device is a first XR device, wherein the one or more components are configured to:
capture video associated with a view of the user when the user is within the physical retail store;
transmit the video to a second XR device; and
receive, from the second XR device, a communication based on the video associated with the view of the user, wherein the communication is associated with the items to be purchased at the physical retail store.

13. A method, comprising:
receiving, via an interface of an extended reality (XR) device, an indication of items to be purchased;
identifying, by the XR device, a theme associated with the items;
identifying, by the XR device, one or more recommended items based on the theme;
providing, via the interface, a list of items that includes the items to be purchased and the one or more recommended items;
identifying, by the XR device and based on the theme, one or more physical retail stores that carry items in the list of items;
providing, via the interface, a list of the one or more physical retail stores;
detecting, by the XR device, that the XR device is within a physical retail store, of the one or more physical retail stores, based on a geographic location associated with the XR device; and
providing, via the interface, an in-store navigation path for directing a user of the XR device via overlayed audio-visual cues to locations within the physical retail store at which items included in the list of items are held.

14. The method of claim 13, further comprising:
receiving, via the interface, a set of preferences associated with the user; and
verifying that the one or more recommended items are aligned with the set of preferences.

15. The method of claim 13, further comprising:
retrieving, from a server, store mapping information that indicates a map of store aisles and corresponding items that are available for sale in the store aisles;
determining, using a camera of the XR device, a current location within the physical retail store;
determining a next item on the list of items;
determining, based on the store mapping information, a next location in the physical retail store that is associated with the next item; and
providing, via the interface, the in-store navigation path to direct the user via the overlayed audio-visual cues from the current location to the next location associated with the next item.

16. The method of claim 13, further comprising:
determining, based on store information associated with the physical retail store, an additional item that is offered at a discounted price at the physical retail store, wherein the additional item is related to the theme; and
providing, via the interface, the in-store navigation path to direct the user to a location within the physical retail store at which the additional item is held.

17. The method of claim 13, further comprising:
detecting, via a camera of the XR device, that an item included in the list of items is added to a shopping cart; and
providing, via the interface, the in-store navigation path to direct the user to a next location within the physical retail store, wherein the next location is associated with a next item in the list of items or a checkout location in the physical retail store.

18. The method of claim 13, further comprising:
detecting, using a camera of the XR device, a gaze associated with the user;
identifying, based on an object recognition, an item for sale in the physical retail store that is aligned with the gaze associated with the user;
determining that the item corresponds to the theme associated with the list of items; and
providing, via the interface, a suggestion to purchase the item.

19. The method of claim 13, further comprising:
detecting, using a sensor of the XR device, an attention-based behavior of the user while in a certain area of the physical retail store;
identifying, based on an object recognition, an item for sale in the certain area of the physical retail store, wherein the item corresponds to the theme associated with the list of items;
determining that the item corresponds to a category associated with the items; and
providing, via the interface, a suggestion to purchase the item.

20. The method of claim 13, wherein the XR device is a first XR device, and further comprising:
capturing video associated with a view of the user when the user is within the physical retail store;
transmitting the video to a second XR device; and
receiving, from the second XR device, a communication based on the video associated with the view of the user, wherein the communication is associated with the items to be purchased at the physical retail store.

21. A system, comprising:
a server comprising one or more components configured to:
receive, from an extended reality (XR) device, an indication of items to be purchased;
identify one or more physical retail stores that carry the items; and
transmit, to the XR device, an indication of the one or more physical retail stores; and
the XR device comprising one or more components configured to:
receive, from the server, the indication of the one or more physical retail stores; and
provide, via an interface of the XR device, an in-store navigation path to direct a user of the XR device via overlayed audio-visual cues to locations within a physical retail store, of the one or more physical retail stores, at which the items are held.

22. The system of claim 21, wherein the one or more components of the server are configured to:
determine a category associated with the items; and
identify, from a database, the one or more physical retail stores based on the category associated with the items, wherein the one or more physical retail stores offer items for sale that correspond to the category.

23. The system of claim 21, wherein the one or more components of the server are configured to:
identify the one or more physical retail stores based on user profile information and real-time item inventory information, wherein the user profile information indicates one or more of: a base location associated with the user and a maximum distance that the user is willing to travel, a cost budget, past physical retail stores visited by the user, or user reviews of physical retail stores.

24. The system of claim 21, wherein the one or more components of the XR device are configured to:
determine store mapping information that indicates a map of store aisles and corresponding items that are available for sale in the store aisles;
determine, using a camera of the XR device, a current location within the physical retail store;
determine a next item to be purchased;
determine, based on the store mapping information, a next location in the physical retail store that is associated with the next item; and
provide, via the interface, the in-store navigation path to direct the user via the overlayed audio-visual cues from the current location to the next location associated with the next item.

25. The system of claim 21, wherein the one or more components of the XR device are configured to:
detect, via a camera of the XR device, that one of the items is picked up by the user; and
update a status associated with the items to be purchased.
